(19) United States
(12) Patent Application Publication
(10) Pub. No.: US 2011/0033742 A1
(43) Pub. Date: Feb. 10, 2011

(54) MODULAR BATTERY SYSTEM WITH COOLING SYSTEM

(75) Inventors: Guenter Maier, Graz (AT); Martin Michelitsch, Graz (AT)

Correspondence Address: BACHMAN & LAPOINTE, P.C., 900 CHAPEL STREET, SUITE 1201, NEW HAVEN, CT, 06510, US

(73) Assignee: MAGNA STEYR FAHRZEUGTECHNIK AG & CO. KG, Graz (AT)

(21) Appl. No.: 12/922,275

(22) PCT Filed: Mar. 10, 2009
(86) PCT No.: PCT/EP2009/052807

§ 371 Date: Oct. 22, 2010

(30) Foreign Application Priority Data
Mar. 14, 2008 (DE) 10 2008 014 155.0

(51) Int. Cl. H01M 10/50; F28D 15/00; F28F 27/02

(52) U.S. Cl. 429/120; 165/104.31; 165/100

(57) ABSTRACT

Modular battery system with at least two battery modules (114, 115), wherein each battery module comprises a cooling member (120), through which a coolant (121) at least partially flows, and a battery cell (122), wherein the battery cell (122) is disposed at the cooling member (120) such that a heat-conducting contact is set up between the battery cell and the cooling member and a coolant supply is provided by way of a coolant line (123) for distributing the coolant at the cooling member (120) or for draining the coolant from the cooling member, wherein the coolant line comprises coolant line modules that can be connected together and that form the coolant line at least partially, and wherein a diverting unit (134) is provided in the coolant line for adjusting the flow length of the coolant in the coolant supply to divert the flow direction of the coolant in the coolant line, and the coolant line comprises two flow channels (126, 127) at least in a longitudinal section, the coolant being fed substantially in opposite directions in said flow channels.

### BACKGROUND OF THE INVENTION

The invention relates to a modular battery system with at least two battery modules.

An embodiment of such a battery unit with a temperature control unit is known from EP0065248A1, wherein electrochemical storage cells are arranged in a high-temperature battery.

An alternative embodiment of a battery with a plurality of storage cells and a temperature control unit is known from DE19503085C2.

It is an object of the invention to develop a particularly efficient and low-cost battery system which is distinguished by its modularity and which can be provided for different applications and in different sizes with little effort and at low cost.

### SUMMARY OF THE INVENTION

This object is achieved by a modular battery system and by a method for supplying coolant in a battery system as set forth below.

According to a preferred embodiment of the invention, a modular battery system with at least two battery modules is provided, wherein each battery module has a cooling element, through at least part of which a coolant flows, and a battery cell. In this arrangement, the battery cell is arranged on the cooling element in such a way that heat-conducting contact is established between the battery cell and the cooling element. According to this embodiment, a coolant supply with a coolant carrier for distributing the coolant to the cooling elements or for carrying the coolant away from the cooling elements is furthermore provided, wherein the coolant carrier has coolant carrier modules that are connected to one another and that at least partially form the coolant carrier, and wherein, to enable the flow length of the coolant in the coolant supply to be adapted, a deflection device is provided in the coolant carrier to reverse the direction of flow of the coolant in the coolant carrier, and the coolant carrier has two flow channels at least in one longitudinal portion, in which flow channels the coolant can be carried substantially in opposite directions.

According to a preferred embodiment, the flow channels are aligned uniformly, i.e. parallel. According to other possible embodiments, the flow channels are provided at a maximum directional offset of 45°, 30°, 20°, 15°, 10°, 5° or 2° relative to one another, and the flow length of the coolant can once again be matched or adapted in a suitable way through an appropriate design and arrangement of the coolant carrier modules.

According to a special embodiment, the two flow channels are positioned adjacent to one another in the coolant carrier, and it is therefore possible to speak of two adjacent flow channels.

According to a special embodiment, the battery system according to the invention has a coolant distributor and a coolant collector as coolant carriers. According to a special embodiment of the invention, both the coolant distributor and the coolant collector have two flow channels, at least in part.

According to one embodiment of the invention, an implementation of a fluid-cooled high-voltage energy storage device which is optimized in terms of cost and installation space is provided with the invention illustrated. For this purpose, the overall system is constructed from any number of modules, and these can be produced at low cost, being identical parts. The respective flow of coolant required to cool the battery cell modules should as far as possible be kept constant for all the modules to ensure optimized power output from the overall storage device. To achieve this for all the modules, the total conduit length and the associated pressure loss must be the same for the inlet and outlet of each module. From the point of view of assembly and integration, connecting the coolant feed and the coolant return directly adjacent to one another represents an optimum solution. However, there is the problem when joining up a number of modules that, if the main coolant connections of the storage device are situated adjacent to one another, the conduit lengths of the modules situated closer to the main connection are shorter than the rearward modules. By the very nature of the situation, this results in a larger volume flow in the forward modules and, as a result, these modules are cooled better. To prevent this, the return could be passed out on the opposite side from the connection, and then routed back to the common main connection on the other side of the storage device via a dedicated channel. However, on the one hand this requires additional installation space and, on the other hand, it requires additional components, and this would considerably increase the costs of such a battery system. According to the invention, therefore, one embodiment of the invention proposes a coolant carrier with a plurality of, in particular two, integrated flow channels. The coolant is first of all carried in a first, in particular inner flow channel or flow channel situated on the inside in the coolant carrier at least partially to the opposite side from the feed and, after deflection in the opposite direction, is distributed between the cooling elements of the battery modules. This ensures at least approximately the same conduit length for all the modules. At the same time, the fact that the coolant conduit modules, in particular the suitable tube sections used in accordance with a preferred embodiment, can be plugged into one another means that virtually any desired number of modules can be plugged in or combined in series without the need for a major design effort or for additional components.

According to one embodiment of the invention, a very wide variety of cooling media can be used as coolants. Gaseous and/or liquid cooling media are conceivable. According to a special embodiment, the coolant is a cooling liquid and, according to a special embodiment, contains at least a proportion of water and, if appropriate, chemical additives.

According to one embodiment of the invention, the flow channels have at least partially variable flow cross sections in the longitudinal direction. In this way, the flow resistance can be appropriately set in a known manner. It is thereby possible to ensure even more uniform flow through the cooling element.

According to a special embodiment of the invention, the two flow channels of the coolant carrier adjoin one another, in particular directly. According to a special embodiment, the two flow channels have at least one common sealing surface, or their sealing surfaces are at least partially shared.

According to one embodiment of the invention, the longitudinal portion of the coolant carrier is formed at least partially by one of the coolant carrier modules of the coolant carrier.

According to one embodiment of the invention, the longitudinal portion of the coolant carrier is formed at least by two coolant carrier modules of the coolant carrier.

According to a special embodiment of the invention, one coolant carrier module in each case is associated with one, two or three battery modules.

According to one embodiment of the invention, the coolant carrier modules are designed at least partially as hollow pieces.

According to one embodiment of the invention, the coolant carrier is designed at least partially as an elongate hollow body, and the deflection device is configured in such a way that it deflects the flow of coolant substantially by 180°.

According to one embodiment of the invention, in the longitudinal portion, the coolant carrier has at least two substantially separate cavities transversely to the longitudinal direction which cavities form the two flow channels. By definition, substantially separate cavities are understood to mean those which are completely separated by an appropriate contour of a profile or in which, if there are openings between the cavities, only a very small proportion of the coolant delivered, in particular less than 10%, preferably less than 5% or 2%, of the quantity of coolant pumped through the flow channels, can pass through these openings during operation.

According to one embodiment of the invention, in the longitudinal portion, the coolant carrier has at least one lateral opening leading to one of the two cavities.

According to one embodiment of the invention, at least one of the cooling elements has a cooling channel to allow coolant to flow through, and the lateral opening of the coolant carrier is operatively connected to the cooling channel. According to other possible embodiments, the cooling element has a plurality of cooling channels, which are each connected in series or in parallel with the coolant supply by the coolant distributor, in particular with one of the openings in the coolant distributor.

According to one embodiment of the invention, in the longitudinal portion, the coolant carrier has, in a cross section, a first profile and a second profile, which is arranged at least partially within the first profile, with a first of the two flow channels being formed by a first flow cross section in the interior of the second profile and a second of the two flow channels being formed by a second flow cross section between the first and the second profile.

According to one embodiment of the invention, the second profile at least partially forms the outer contour of the coolant carrier.

According to one embodiment of the invention, the first and the second profile have a substantially tubular cross section.

According to one embodiment of the invention, the deflection device is provided as an end piece of the coolant carrier, the end piece adjoining the longitudinal portion of the coolant carrier and closing the latter in a leaktight manner.

According to one embodiment of the invention, the coolant carrier has, in the longitudinal portion, an outer, substantially cylindrical profile with a first diameter. Here, the first flow channel is formed by a substantially cylindrical inside diameter arranged within the first diameter. According to a special embodiment, the inside diameter is formed by a further profile. According to one embodiment, the second flow channel at least partially surrounds the first flow channel.

According to one embodiment of the invention, the deflection device is provided as an end piece of the coolant carrier, the end piece adjoining the outer profile of the coolant carrier and closing the coolant carrier.

According to one embodiment of the invention, the coolant carrier is of one-piece design in the longitudinal portion.

According to one embodiment of the invention, the coolant carrier is configured as a coolant distributor for distributing the coolant from a coolant supply device, in particular a coolant reservoir or a coolant pump, to the cooling element.

According to one embodiment of the invention, the coolant carrier is configured as a coolant collector for carrying the coolant away from the cooling element to a coolant supply device, in particular a coolant reservoir or a coolant pump.

According to one embodiment of the invention, the at least two battery modules have a first and a second battery module arranged in series, wherein the coolant carrier is embodied as a first coolant carrier, and a second coolant carrier is furthermore provided, and the first coolant carrier is arranged on a first side of the first and second battery module, and the second coolant carrier is arranged on a second side of the first and second battery module, in particular the opposite side from the first side.

According to one embodiment of the invention, at least one further battery module is arranged on that side of the first coolant carrier which faces away from the first and second battery module.

According to a further embodiment, the invention is characterized by a battery system.

According to one embodiment of the invention, the coolant distributor modules are designed at least partially as hollow pieces. According to one embodiment of the invention, in the longitudinal portion, the coolant distributor has at least two substantially mutually separate cavities transversely to the longitudinal direction of the coolant distributor, and the coolant distributor has at least one lateral opening leading to one of the at least two cavities and the lateral opening of the coolant carrier is connected to one of the cooling channels of one of the cooling elements.

According to one embodiment of the invention, the coolant distributor is designed at least partially as an elongate hollow body. According to one embodiment, the deflection device is configured in such a way that it deflects the flow of coolant substantially by 180°.

According to one embodiment of the invention, in the longitudinal portion, the coolant distributor has, in a cross section, a first profile and a second profile, which is arranged at least partially within the first profile, with a first of the at least two flow channels being formed in the interior of the second profile and a second of the at least two flow channels being formed in the space between the first and the second profile, the first and the second profile having a substantially tubular cross section and the second flow channel at least partially surrounding the first flow channel.

According to a further embodiment, the invention is characterized by a method.

### BRIEF DESCRIPTION OF THE DRAWINGS

The invention is described and explained below with reference to illustrative, non-limitative and schematic figures. In the drawing:

FIG. 1 shows a battery module according to the invention in an axonometric view

FIG. 2 is similar to FIG. 1 but without the cover

FIG. 3 shows an end view in accordance with A in FIG. 2

FIG. 4 shows an end view in accordance with B in FIG. 2

FIG. 5 shows a longitudinal section in accordance with V-V in FIG. 3 and FIG. 4

FIG. 6 shows another possible embodiment of a battery unit according to the invention

FIG. 7 shows the cooling element from FIG. 6 in a longitudinal section

FIG. 8 shows a battery system composed of a plurality of battery units in accordance with FIG. 6

FIG. 9 shows various possible embodiments of battery units

FIG. 10 shows an alternative embodiment of a cooling element

FIG. 11 shows a battery system according to the invention in a plan view

FIG. 12 shows part of the battery system according to the invention in an isometric view, with a coolant distributor being shown in a longitudinal section

FIG. 13 shows a view of the coolant distributor in a first cross section

FIG. 14 shows a view of the coolant distributor in a second cross section

FIG. 15 shows the view in accordance with FIG. 13

FIG. 16 shows a simplified view of a longitudinal section through a coolant distributor module and the end piece

FIG. 17 shows a simplified view of a longitudinal section through a coolant distributor module and the feed

FIG. 18 shows part of the battery system according to the invention from FIG. 11, featuring individual components in some cases

FIG. 19 shows a simplified view of a longitudinal section through a coolant collector module

### DETAILED DESCRIPTION

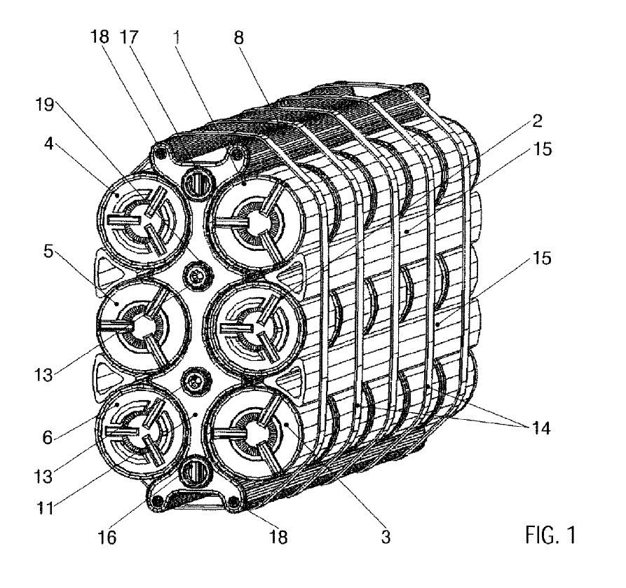

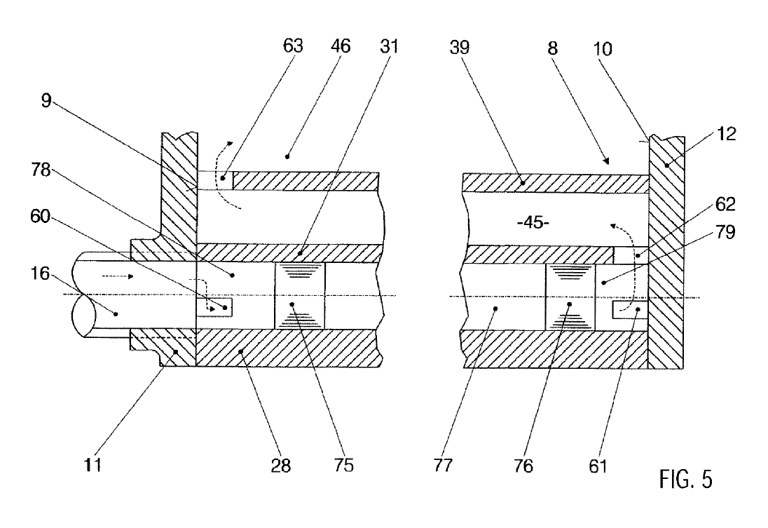

In FIG. 1, the battery cells, which are arranged in two parallel rows, are provided with reference signs 1 to 6, battery cells 1 to 3 forming a first row and cells 4 to 6 a second row. The cells can be high power cells of any desired construction and mode of chemical operation. They are, for example, cylindrical, and extend either over the entire length of the battery or, as in the illustrative embodiment shown, are composed of a plurality of, in particular three, individual cells arranged in series. Apart from cylindrical cells, battery cells with a square or prismatic cross section are also conceivable, however. There is no need to give details of the electrical connections and terminals because they are not essential to the invention. Extending between two rows of cells, over the entire length, is a cooling element 8 or support plate, through which the coolant flows in a manner that will be described below. Said cooling element is an extruded section, preferably composed of light alloy, or some other suitable material. Producing the cooling element by extrusion makes it possible to produce a hollow body that is open at both ends and has a complex cross section with a low outlay on production. A section produced in this way and cut into pieces of the same length as the battery unit is closed at its two end faces 9, 10 thus formed by covers or covering caps 11 and 12 respectively (see FIG. 5). The covering caps 11, 12 can also be designed in such a way that they hold and/or fix the cells 1 to 6, in particular in the longitudinal direction thereof.

The two covering caps 11, 12 are held together by first tensile elements 13 (long threaded bolts, for example). For this purpose, the covers 11, 12 are provided with holes 18 at the edge and holes 19 in the central region of the support plate 8. All the cells 1 to 6 of the battery are pressed against the cooling element 8 and held together by second or outer tensile elements 14, in this case tension straps. Mounted between each of the second or outer tensile elements 14 and that contour of the cells to 6 which faces away from the support plate 8 there is an approximately triangular hollow longitudinal profile 15. The word “approximately” is used because two sides form concave cylindrical surfaces which come to rest against two cells in each case. Also provided in the front covering cap 11 are holes 16, 17 for connection to the cooling circuit, the lower hole (16) being for the inlet and the upper hole (17) being for the outlet.

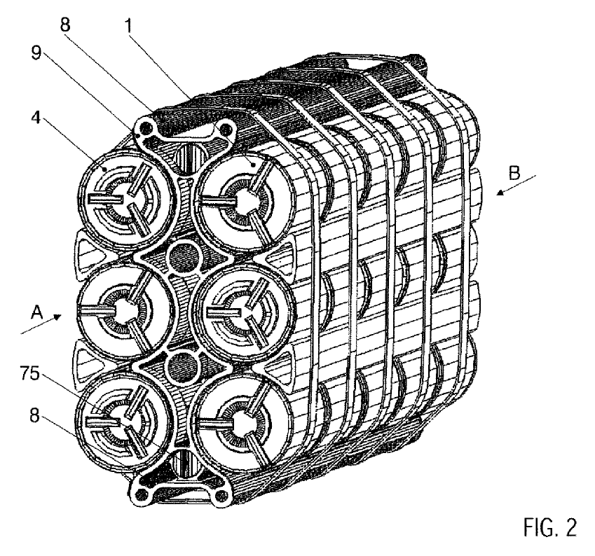

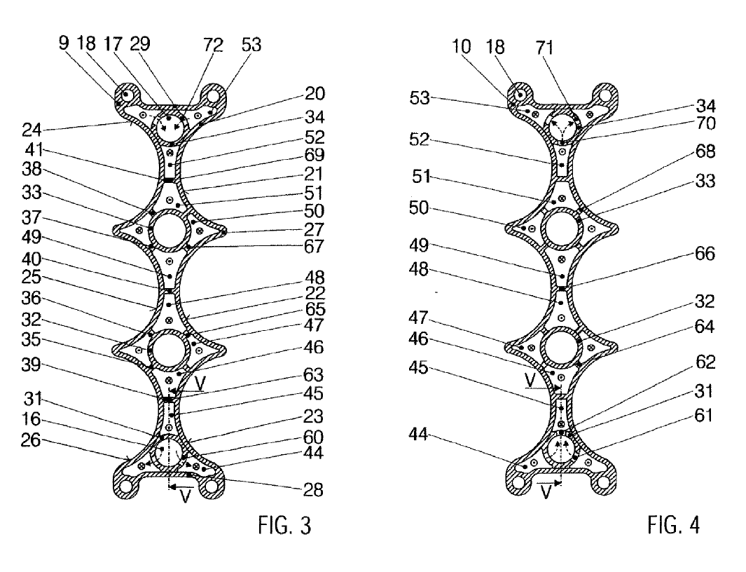

FIG. 2 shows the same battery with the front covering cap 11 removed, exposing the end face 9 of the extruded section and hence its cross section to the observer. In FIG. 3, it is shown on an enlarged scale and without the cells.

The front end face 9 of the extruded section is shown separately in FIG. 3, and the rear end face 10 of the extruded section is shown separately in FIG. 4. The outer wall, denoted overall by 20, of the extruded section forms recesses 21 to 26 in the form of circular arcs for the cells 1 to 6, which are thus arranged back-to-back and adjacent to one another in pairs. The outer wall 20 furthermore forms a lower transverse wall (28) and an upper transverse wall (29). Holes 18 for additional first tensile elements are made at the transition from the recesses to the transverse walls 28, 29.

A number of cooling channels (44-53) extending in the longitudinal direction are formed within this outer wall 20 by means of various walls. Thus, there is a first tubular profile 31 between the lower transverse wall 28 and the parts forming the recesses 23, 26, said profile making contact with the three outer wall parts and forming as it were an inscribed circle. An exactly similar first tubular profile is arranged between the upper transverse wall 29 and those parts of the outer wall 20 which form the recesses 21, 24.

A second tubular profile 33 is formed between the wall parts that here form the recesses 21, 22, 25 and 24, at the widest point, at the level of the ridges 27. Intermediate walls 37, 38 project out in a star shape to the outer wall parts forming the recesses. In the same way, a second tubular profile 32 with the intermediate walls 35, 36 is formed between the recesses 22, 23, 25, 26. There are partition walls 39, 40, 41 at the approximately narrowest points of the extruded section.

These intermediate walls 35-38 and partition walls 39-41 form mutually separate flow channels, in which, according to one illustrative embodiment, the direction of flow alternates between adjacent flow channels. The directions of flow are indicated in the conventional manner in FIG. 3: a circle containing a dot represents an arrow pointing toward the observer while a circle containing a cross indicates an arrow pointing away from the observer. In FIG. 4, which shows the rear end face 10, the symbols for the direction of flow in one and the same channel are the reverse of those in FIG. 3.

In this way, the following channels are formed: two symmetrical first channels 44, through which the flow is toward the rear end face 10; a second channel 45, through which the flow is toward the front end face 9; a third channel 46, through which the flow is toward the rear end face 10; two symmetrical fourth channels 47, through which the flow is toward the front end face 9; a fifth channel 48, through which the flow is toward the rear end face 10; a sixth channel 49, through which the flow is toward the front end face 9; two symmetrical seventh channels 50, through which the flow is toward the rear end face 10; an eighth channel 51, through which the flow is toward the front end face 9; a ninth channel 52, through which the flow is toward the rear end face 10; and two symmetrical tenth channels 53, through which the flow is toward the front end face 9.

To redirect the flow at the end faces, corresponding redirection channels could be milled into the inside of the covering caps 11, 12. According to the invention, however, they are produced by means of notches in the intermediate walls and partition walls of the extruded section 8, said notches starting from the end faces 9, 10. Since all these notches start from one of the two end faces 9, 10, they can be made with little outlay in terms of production, e.g. by milling.

In FIG. 3, the notches starting from the front end face 9 are provided with the following reference signs: 60 in the tubular profile 31 for the purpose of connecting the inlet 16 to the first channels 44; 63 in the partition wall 39 for the purpose of connecting the second channel 45 to the third channel 46; 65 in the intermediate walls 35 for the purpose of connecting the two fourth channels 47 to the fifth channel 48; 67 in the intermediate walls 37 for the purpose of connecting the sixth channel 49 to the two seventh channels 50; 69 in the partition wall 41 for the purpose of connecting the eighth channel 51 to the ninth channel 52; 72 for the purpose of connecting the two tenth channels 53 to the outlet 17. Instead of using notches 60, 62, 70, 71, the tubular wall parts 31, 34 can be set back in the longitudinal direction.

FIG. 4 shows the notches in the rear end face 10: 61 and 62 for the purpose of connecting the two first channels 44 to the second channel 45; 64 in the intermediate walls 35 for the purpose of connecting the third channel to the two fourth channels 47; 66 in the partition wall 40 for the purpose of connecting the fifth channel 48 to the sixth channel 49; 68 in the intermediate walls 38 for the purpose of connecting the seventh channels 50 to the eighth channel 51; 70 and 71 in the tubular profile 34 for the purpose of connecting the ninth channel 52 to the two tenth channels 53.

The notches in the first tubular profiles 31, 34 result in a special feature which will be explained with reference to FIG. 5.

FIG. 5 shows that the first tubular profile 31, which is connected to the inlet 16 of the coolant, has respective plugs 75, 76 in the vicinity of the front cover 11 and in the vicinity of the rear covering cap 12. These plugs 45, 46 separate an entry space 78 on one side and a passage space 79 on the other side from a closed space 77, through which there is no flow, between the two plugs 75, 76. Thus, the cooling liquid entering through the inlet 16 flows into the entry space 78 and, from the latter, through the notches 60 (see FIG. 3) into the two first channels 44, which are situated in front of and behind the plane of the figure in FIG. 5, and on both sides of the first tubular profile in FIG. 3. At the other end of the first channels 44, the cooling medium flows through the notches 61 into the passage space 79 and, from the latter, via notch 62 into the second channel 45. At the front end face 9, the cooling medium then flows through notch 63 into the third channel 46, and so on.

The flow in the first tubular profile 34 is directed to the outlet 17 in a similar way, except in the opposite direction.

This is one illustrative embodiment. As a departure from the latter, it is also possible, within the scope of the invention, for the cells to be arranged in more than two rows and/or offset relative to one another and for the support plate to be shaped in an appropriately different way. In this case too, it is possible, given suitable arrangement of the internal walls, to achieve a situation where the directions of flow in adjacent channels are mutually opposed. Uniform temperature distribution at the surface of the support plate will thereby be achieved while keeping production as simple and cheap as possible.

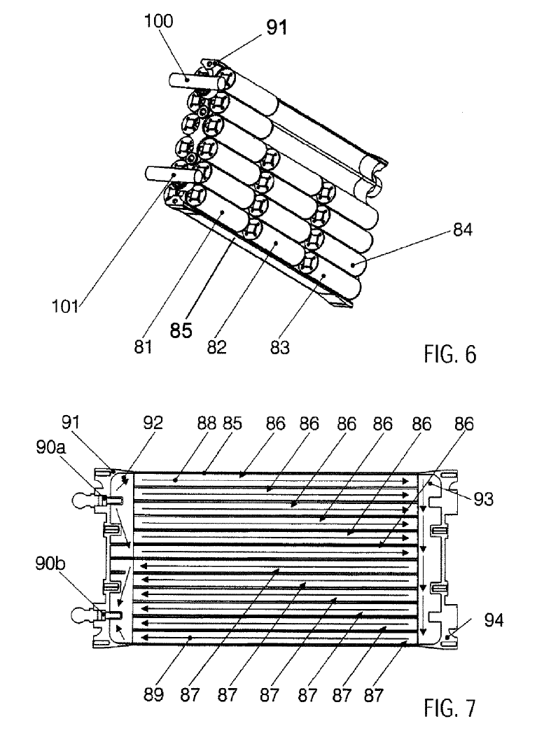

FIG. 6 shows another possible embodiment of a modular battery unit 80 according to the invention. Here, a plurality of battery cells 81, 82, 83, 84 are arranged on a cooling element 85. Here, the battery cells are adhesively bonded or pressed onto the cooling element 85 or brought into contact therewith in some other way, thus enabling heat generated by the battery cells during operation to be transferred to the cooling element 85. As can be seen from FIG. 6, a plurality of battery cells 81, 82, 83 can be arranged in series on the cooling element 85, along the longitudinal side of the latter. This is advantageous particularly in the case where the cooling element is formed from an extruded section, for example, and its length can be adapted to the available installation space. This enables the extruded section to be cut to the required length. Given that battery cells are generally available only in standard sizes, a plurality of relatively short battery cells are in this way arranged in series in order to make the best possible use of the full length of the cooling element and the available installation space.

A vertical longitudinal section through the cooling element 85 along a center plane is shown in FIG. 7. This shows the channels 86, 87 formed in the cooling element 85. In the schematic representation in FIG. 7, the directions of flow of the cooling medium are furthermore indicated by corresponding arrows 88, 89 in the channels 86, 87. It can be seen here that, in a first, upper zone, the cooling medium fed into the covering cap 91 via an inlet 90a is distributed in a separate distribution space 92 in the covering cap 91 before being passed to the opposite side of the cooling element 85 via the channels 86, 87 of the cooling element 85 and into a defined distribution space 93 in the second covering cap 94. From this distribution space 93, the cooling medium is then passed once again to the opposite side and into a collecting space or distribution space 94 in the first covering cap 91. From this collecting space 94, the cooling medium is discharged from the battery unit via an outlet 90b arranged in or at the covering cap 91. The cooling element is thus divided vertically into two, whereby a cooling medium flows from a first to a second side in a first, upper zone, and cooling medium flows back from the second to the first side in a second, lower zone.

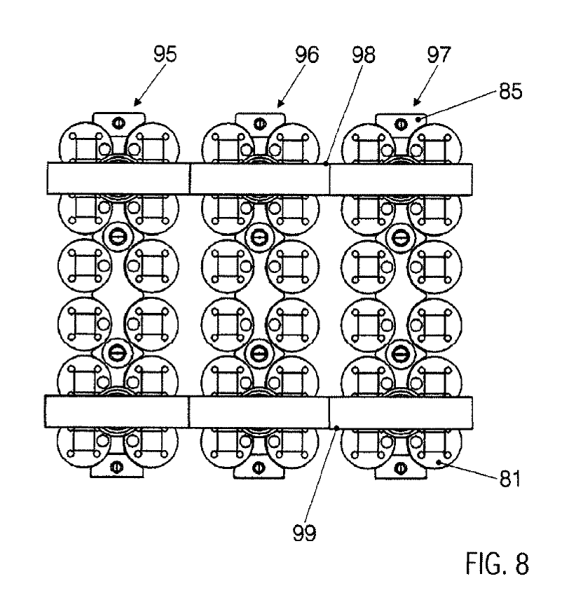

In FIG. 8, a plurality of modular battery units 95, 96, 97 are combined to form a battery system. For this purpose, the inlets and outlets 98 are connected to one another by suitable distributor rails 98, 99, which preferably have integrated seals, e.g. O-rings. As can be seen from FIG. 8, an upper distributor rail 98 is provided for the purpose of connecting the inlets, and a lower distributor rail 99 is provided for the purpose of connecting the outlets. In another embodiment, the positions of the inlets and outlets can, of course, be interchanged. Each battery unit preferably already incorporates parts of the distributor rails 98, 99 and is therefore equipped with a first and a second distributor rail element 100, 101 on its covering cap 85, as illustrated schematically in FIG. 6, thereby enabling the distributor rails to be formed essentially by plugging the distributor rail elements of the battery units into one another.

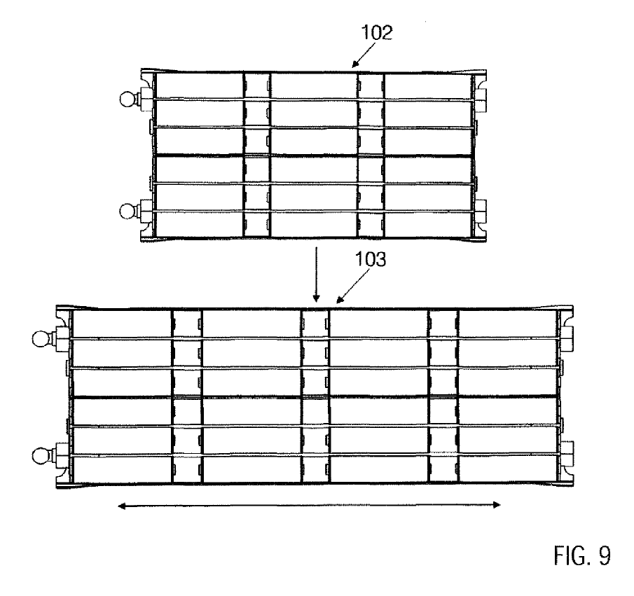

One particular advantage of the embodiment according to the invention of the modular battery unit is the fact that it can be adapted in a simple manner to the available installation space. Given that the cooling element is generally produced from an extruded section, it can be cut to size or fitted in in virtually any length. Depending on the installation space, it is accordingly possible to produce battery units 102, 103 of any desired length, as illustrated in simplified form in FIG. 9. Depending on the length of the cooling element, suitable battery cells are used or a plurality of battery cells is arranged in series in order as far as possible to make use of the full length of the cooling element. For this purpose, a first embodiment of a battery unit is illustrated at the top in FIG. 9, in which battery unit 3 rows of battery cells are arranged in series on the cooling element while, at the bottom, in a second embodiment, 4 rows of vertically arranged battery cells are arranged in series on the cooling element. As can be seen, although the two embodiments differ in terms of their length and of the length of their cooling elements, the cooling element is identical in terms of its profile and, in particular, is produced from a single extruded section. The battery cells used in the two embodiments do not differ either.

According to another preferred embodiment of the invention, the battery units are arranged in series and, if appropriate, are connected on the one hand by their inlets and on the other hand by their outlets. In this way, it is possible to implement large battery systems with a correspondingly high power.

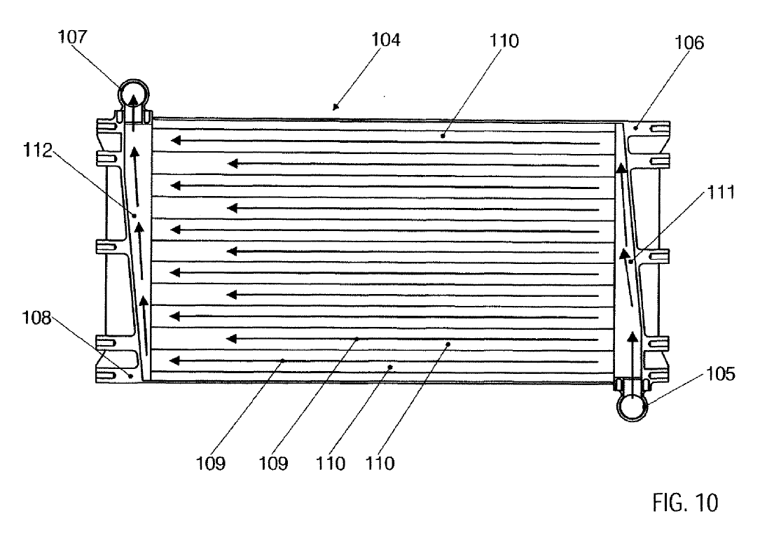

Another possible embodiment of a cooling element 104 is illustrated schematically in FIG. 10. As in FIG. 7, this figure likewise shows a longitudinal section through one possible embodiment of a cooling element. This embodiment differs from the other illustrative embodiments shown in that the inlet 105 is arranged in or at a first covering cap 106 and the outlet 107 is arranged in or at the opposite, second covering cap 108. As can furthermore be seen from FIG. 10, the cooling medium is carried through the cooling element 104 in the same direction in substantially parallel channels 110, as illustrated by arrows 109 to indicate the direction of flow of the cooling medium. In the covering caps 106, 108 there are what are referred to as distribution or collecting spaces 111, 112 in order, on one side, to distribute the cooling medium from the inlet 105 to the individual channels 110 and, on the opposite side, to collect the cooling medium from the channels 110 and direct it to the outlet 107.

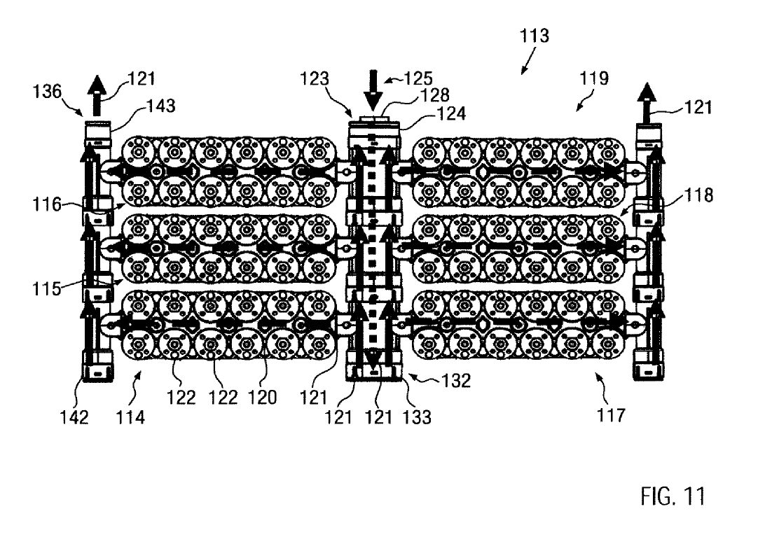

FIG. 11 shows a modular battery system 113 with six battery modules 114, 115, 116, 117, 118, 119. As illustrated by way of example by battery module 114, battery module 114 has a cooling element 120, through which a coolant 121 flows along a cooling channel (not shown). As regards the cooling channel, attention is drawn to the illustrative embodiments in FIGS. 3-10. Arranged on the cooling element 120 is a number of battery cells 122 (for the sake of clarity, only some of these are referenced in FIG. 11) and, in the case illustrated, 6 battery cells are arranged on each of the two sides of the cooling element 120. As can be seen from FIG. 11, the battery modules 114, 115, 116, 117, 118, 119 are arranged in series in two rows. As can be seen in FIG. 11, the battery cells 122 are here aligned along the line of sight of the observer. As can furthermore be seen from FIG. 11, a coolant distributor 123 is arranged between the two rows of battery modules. The coolant 125 is fed to the coolant distributor 123 via a feed module 124. The feed module 124 can be used to connect a coolant supply device, in particular a coolant pump and/or a coolant reservoir (not shown), for example.

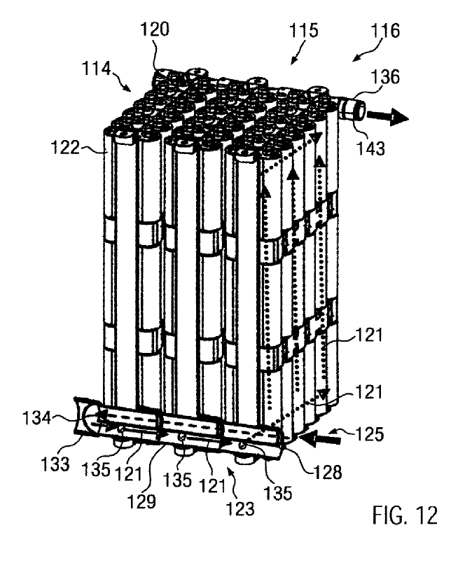

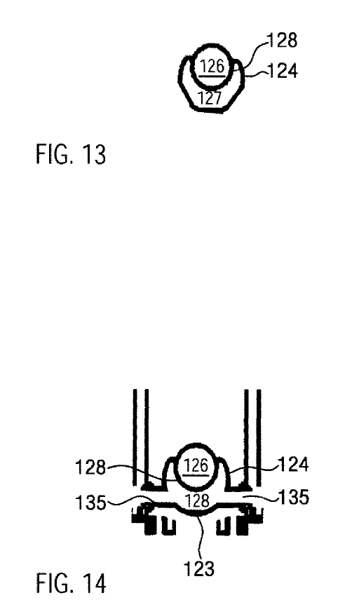

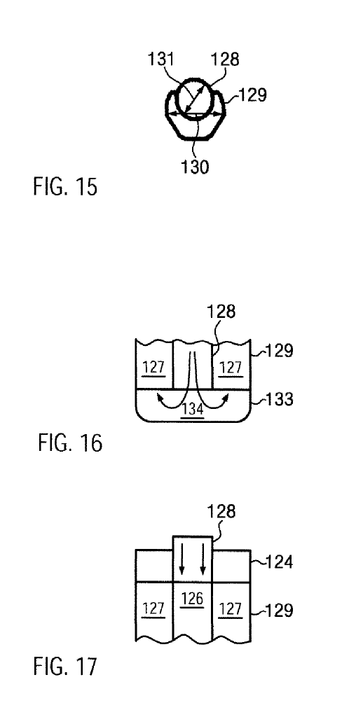

FIG. 12 shows a longitudinal section through one possible embodiment of a coolant distributor 123 according to the invention. In the view according to FIG. 12 in conjunction with FIGS. 13 and 14, it is possible to see in the cross section of the coolant distributor 123 that the coolant distributor 123 has two flow channels 126, 127. A preferred direction of flow of the coolant is indicated by direction arrows 121 in FIGS. 11 to 19. A first flow channel 126 is formed by a first tubular conduit 128, which is in turn surrounded at least partially by a second tubular conduit 129, within which the second flow channel 127 is formed. As can be seen in FIGS. 13-15, the coolant distributor 123 has a substantially cylindrical outside diameter 130 or a first tubular profile to form the second flow channel 127, and a substantially cylindrical inside diameter 131 or a second tubular profile to form the first flow channel 126. In this arrangement, the second flow channel 127 at least partially surrounds the first flow channel 126.

As is readily apparent in FIG. 13, the coolant carrier, in the present case the coolant distributor, has two separate cavities in cross section, said cavities forming the corresponding flow channels. It is furthermore apparent in FIG. 14 that, in the region of the connection of one or more cooling elements, the outer cavity or second flow channel has at least one and, in the illustrative case shown, two openings 135, via which the coolant distributor can supply one or more cooling elements with the coolant. To ensure the supply to the cooling element, suitable connection pieces are furthermore provided between the opening of the coolant distributor and the cooling channel of the cooling element, if required. In the region of the feed 124, the coolant 121 is first of all introduced into the first flow channel 126 and is carried therein as far as the front end 132 of the coolant distributor 123. In FIG. 11, the path of the coolant 121 in the coolant distributor 123 is indicated in simplified and illustrative form by a dashed arrow 121. The coolant distributor 123 has an end piece 133 with a deflection device 134, thereby enabling the direction of flow of the coolant to be changed substantially by 180°. The deflection is shown by way of example in FIG. 12 and FIG. 16 using two different embodiments.

According to a special embodiment, the deflection device 134 has an at least partially rounded and, in particular, at least partially spherical surface, by means of which the direction of flow of the coolant can be changed in an appropriate manner. By means of appropriate rounding and the associated guidance, it is possible to counteract the formation of a high backpressure during the deflection of the coolant. The deflection device 134 can be used not only to deflect the direction of flow of the coolant but also to introduce the coolant into the second flow channel 127. In the second flow channel 127, the coolant 121 subsequently flows back in the direction of the feed. However, the second flow channel is closed with respect to the feed, with the result that the coolant can flow into the cooling element 120, in particular into the cooling channel of the cooling element 120, via suitable lateral openings 135 in the second flow channel or the second tubular conduit forming the second flow channel 127, in order to ensure cooling at said cooling element. After flowing through the cooling element 120, the coolant is discharged once again from the battery modules via a coolant collector 136, which is likewise of tubular construction, and is passed to a coolant supply device, in particular a coolant reservoir and/or a coolant pump, for example.

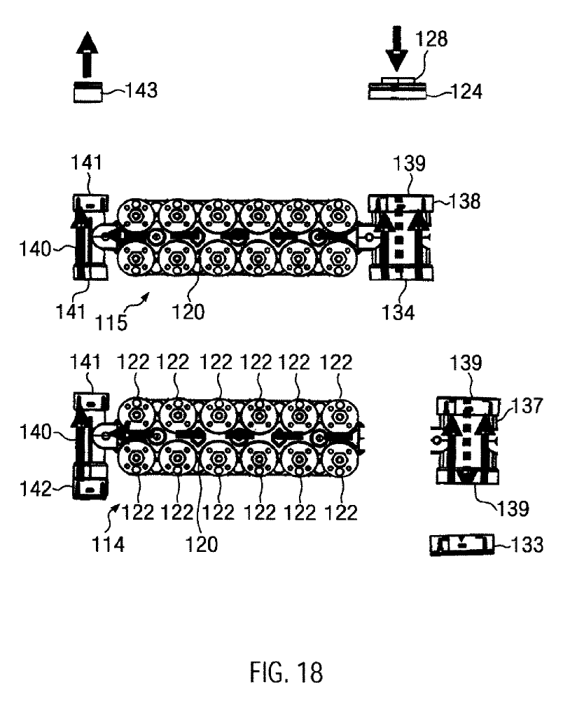

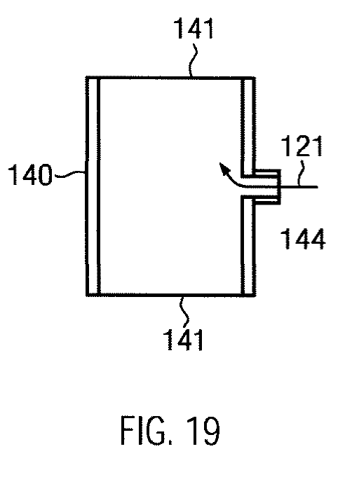

As can be seen in FIG. 19, the coolant collector 136 likewise has one or more lateral openings 144 for this purpose, via which openings the coolant can flow out of the cooling element 123, in particular out of the cooling channel of the cooling element 123, into the coolant collector 136. As can be seen schematically from FIG. 18, the illustrated possible embodiment of a battery system is distinguished particularly by its modularity. By joining up the battery modules 114, 115, 116, 117, 118, 119 in series, it is possible to produce battery systems of any desired complexity. The modularity of the battery system also manifests itself in the modularity of the cooling system. As can be seen from FIG. 18, the coolant carriers, i.e. the coolant collector and/or the coolant distributor, each have coolant carrier modules which, through assembly, form the ready-to-operate coolant carrier. For this purpose, in the case of the coolant distributor 123, individual coolant distributor modules 137, 138 are provided, which optionally already form part of the battery modules and/or are connected to the battery module and/or to the cooling element, as shown in FIG. 18 using battery module 115 and coolant distributor module 138 as examples. According to another embodiment, the coolant distributor modules can be connected as additional or separately assembled parts to the battery modules, in particular to the cooling elements of the battery modules. The second case is shown in FIG. 18 using battery module 114 and coolant distributor module 137 as examples. The coolant distributor modules 137, 138 each have at both ends connection surfaces 139, at which a further coolant distributor module (using the connection surface thereof), an end piece 133, a feed module 124 or some other connected part can be arranged, if appropriate. According to a preferred embodiment, the coolant collector 136 has the same modularity as the coolant distributor 123. The coolant collector modules 140 therefore likewise have suitable connection surfaces 141, at which further coolant collector modules, end pieces 142 or discharge modules 143 for carrying the coolant away from the coolant collector 136, in particular to a coolant supply device, preferably a coolant reservoir and/or coolant pump, can be arranged. According to a special embodiment, an illustrative coolant collector module 140, as shown in a longitudinal section in FIG. 19, has at least one lateral opening 144, through which coolant flows out of the battery module 114, in particular the cooling element 120, into the coolant collector 136 and can be discharged from the latter.

In the illustrative embodiment shown in FIGS. 11 to 19, the coolant distributor 123 is constructed with two flow channels, which make it possible for the coolant to flow in opposite or approximately opposite directions, at least in a partial area or longitudinal portion of the coolant carrier. According to another possible embodiment, it is, of course, also possible to fit the coolant distributor, the coolant collector or both coolant carriers at least partially with two or more than two flow channels, as appropriate. According to one embodiment of the invention, the aim is to match the flow length of the coolant between the feed 124 and the discharge module 143 through the various battery modules, in particular through the various cooling elements. By means of the solution illustrated, it is possible to ensure that the flow path of the coolant 121 through each of the cooling elements of the battery modules is at least approximately the same length. This is important particularly when the feed and discharge are on the same side of the battery system since, otherwise, the battery modules positioned close to the feed and discharge would represent a significantly shorter flow path for the coolant and would therefore receive preferential cooling. Battery modules that were positioned further away from the feed and/or discharge would thus receive little and, possibly, insufficient cooling.

According to a special embodiment of the invention, a tube-in-tube system with at least two rows of battery modules is provided, in which any number of modules can be plugged into one another in series. The coolant is first of all carried in an inner tube to the opposite side from the feed and, after deflection in the opposite direction, is distributed between the battery modules. This ensures the same conduit length for all the battery modules and cooling elements. At the same time, the plug-in coolant carrier tube sections make it possible to plug any number of modules into one another in series, without the need for additional components.

1-18. (canceled)

19. A modular battery system comprising at least two battery modules, wherein each battery module has a cooling element, through at least part of which a coolant flows, and a battery cell, wherein the battery cell is arranged on the cooling element in such a way that heat-conducting contact is established between the battery cell and the cooling element, and a coolant supply with a coolant carrier for distributing the coolant to the cooling elements or for carrying the coolant away from the cooling elements is provided, wherein the coolant carrier has coolant carrier modules that can be connected to one another and that at least partially form the coolant carrier, and wherein, to enable the flow length of the coolant in the coolant supply to be adapted, a deflection device is provided in the coolant carrier to reverse the direction of flow of the coolant in the coolant carrier, and the coolant carrier has two flow channels at least in one longitudinal portion, in which flow channels the coolant can be carried substantially in opposite directions.

20. The modular battery system as claimed in claim 19, wherein the longitudinal portion of the coolant carrier is formed at least by two coolant carrier modules of the coolant carrier.

21. The modular battery system as claimed in claim 20, wherein the coolant carrier modules are designed at least partially as hollow pieces, and the coolant carrier is designed at least partially as an elongate hollow body, and the deflection device is configured in such a way that it deflects the flow of coolant substantially by 180°.

22. The modular battery system as claimed in claim 19, wherein, in the longitudinal portion, the coolant carrier has two substantially separate cavities transversely to a longitudinal direction, which cavities at least partially form the two flow channels.

23. The modular battery system as claimed in claim 22, wherein, in the longitudinal portion, the coolant carrier has a lateral opening leading to at least one of the two cavities.

24. The modular battery system as claimed in claim 23, wherein one of the cooling elements has a cooling channel to allow coolant to flow through, and the lateral opening of the coolant carrier is operatively connected to the cooling channel.

25. The modular battery system as claimed in claim 19, wherein, in the longitudinal portion, the coolant carrier has, in a cross section, a first profile and a second profile, which is arranged at least partially within the first profile, with a first of the two flow channels being formed by a first flow cross section in the interior of the second profile and a second of the two flow channels being formed by a second flow cross section between the first and the second profile.

26. The modular battery system as claimed in claim 25, wherein the second profile at least partially forms the outer contour of the coolant carrier.

27. The modular battery system as claimed in claim 25, wherein the first and the second profile have a substantially tubular cross section.

28. The modular battery system as claimed in claim 19, wherein the deflection device is provided as an end piece of the coolant carrier, the end piece adjoining the longitudinal portion of the coolant carrier and closing the latter in a leaktight manner.

29. The modular battery system as claimed in claim 19, wherein the coolant carrier is configured as a coolant distributor for distributing the coolant from a coolant supply to the cooling element.

30. The modular battery system as claimed in claim 19, wherein the coolant carrier is configured as a coolant collector for carrying the coolant away from the cooling element to a coolant supply.

31. The modular battery system as claimed in claim 19, wherein the at least two battery modules have a first and a second battery module arranged in series, wherein the coolant carrier is embodied as a first coolant carrier, and a second coolant carrier is furthermore provided, and the first coolant carrier is arranged on a first side of the first and second battery module, and the second coolant carrier is arranged on a second side of the first and second battery module.

32. The modular battery system as claimed in claim 31, wherein at least one further battery module is arranged on that side of the first coolant carrier which faces away from the first and second battery module.

33. A battery system comprising at least two battery modules arranged in series, wherein each battery module has a cooling element, through at least part of which a coolant in a cooling channel flows, and a battery cell, which is arranged in heat-conducting contact with the cooling element, and a coolant supply with a coolant distributor for distributing the coolant from a coolant supply device, in particular a coolant reservoir or a coolant pump, to the cooling elements, and a coolant collector for carrying the coolant away from the cooling elements to the coolant supply device, in particular the coolant reservoir or the coolant pump, is provided, wherein the coolant distributor is constructed from coolant distributor modules associated with the cooling elements, and the coolant collector is constructed from coolant collector modules associated with the cooling elements, and a deflection device is provided in the coolant distributor to reverse the direction of flow of the coolant in the coolant distributor, and furthermore the coolant distributor has two flow channels at least in one longitudinal portion, in which flow channels the coolant can be transported substantially in opposite directions, wherein the coolant distributor is arranged on a first side of the cooling elements and the coolant collector is arranged on a second side of the cooling elements.

34. The battery system as claimed in claim 33, wherein, in the longitudinal portion, the coolant distributors has at least two substantially mutually separate cavities transversely to the longitudinal direction of the coolant distributor, and the coolant distributor has at least one lateral opening leading to one of the two cavities, and the lateral opening of the coolant carrier is connected to one of the cooling channels of one of the cooling elements, and furthermore the deflection device is configured in such a way that it deflects the flow of coolant substantially by 180°.

35. The battery system as claimed in claim 33, wherein, in the longitudinal portion, the coolant distributor has, in a cross section, a first profile and a second profile, which is arranged at least partially within the first profile, with a first of the at least two flow channels being formed in the interior of the second profile and a second of the at least two flow channels being formed in the space between the first and the second profile, the first and the second profile having a substantially tubular cross section and the second flow channel at least partially surrounding the first flow channel.

36. A method for supplying coolant in a battery system comprising a plurality of battery modules arranged in series, wherein each battery module has a cooling element, which is embodied with a cooling channel, and a battery cell, which is arranged in heat-conducting contact with the cooling element, wherein a coolant flows through the cooling channel, and a coolant supply with a coolant distributor is provided, the coolant distributor being configured to distribute the coolant from a coolant supply device, in particular from a coolant reservoir or a coolant pump, to the cooling elements, and a coolant collector for carrying the coolant away from the cooling element to the coolant supply device, in particular to the coolant reservoir or the coolant pump, is further provided, wherein the coolant distributor is constructed at least partially from coolant distributor modules, and the coolant collector is constructed at least partially from coolant collector modules, and, to enable the flow length of the coolant through the coolant supply to be adapted, the coolant distributor has, at least in one longitudinal portion, a first and a second flow channel and a deflection device and a number of lateral openings in the second flow channel, and the coolant is passed through the first flow channel in a first step, is deflected substantially by 180° by the deflection device in a second step, and is passed through the second flow channel in a third step before the coolant is fed to the cooling elements via the lateral openings.
